(19) United States
(12) Patent Application Publication
(10) Pub. No.: US 2016/0002438 A1
(43) Pub. Date: Jan. 7, 2016

(54) CORE-SHELL NANOPARTICLES AND METHOD FOR MANUFACTURING THE SAME

(71) Applicant: DIC CORPORATION, Itabashi-ku, Tokyo (JP)

(72) Inventors: Jianjun Yuan, Sakura-shi (JP); Hiroshi Kinoshita, Sakura-shi (JP)

(73) Assignee: DIC CORPORATION, Itabashi-ku, Tokyo (JP)

(21) Appl. No.: 14/770,911

(22) PCT Filed: Jan. 21, 2014
(86) PCT No.: PCT/JP2014/051076

§ 371 Date: Aug. 27, 2015

(30) Foreign Application Priority Data
Mar. 13, 2013 (JP) 2013-050421

(51) Int. Cl. C08K 3/36

(52) U.S. Cl. CPC C08K 3/36

(57) ABSTRACT

Provided are core-shell nanoparticles including a metal nanoparticle core and a shell layer composed of an oxide hybridized with a polyamine containing primary amino groups and/or secondary amino groups, core-shell metal nanoparticles prepared by removing the organic component from the shell layer and including a metal nanoparticle core and a shell layer based on silica, and simple and efficient methods for manufacturing such nanoparticles. Provided are a method for manufacturing a core-shell nanoparticle including performing a sol-gel reaction of an oxide source (C′) in the presence of a metal nanoparticle (A) having thereon a layer of a compound (B) containing a polyamine segment (b1) containing primary amino groups and/or secondary amino groups, a method for manufacturing a core-shell metal nanoparticle further including performing a sol-gel reaction of an organosilane to form a shell layer containing a polysilsesquioxane (D), and nanoparticles prepared by such methods.

### TECHNICAL FIELD

The present invention relates to core-shell nanoparticles including a metal core and a shell layer containing an oxide and an organic component, core-shell nanoparticles prepared by removing the organic component from the nanoparticles, and simple methods for manufacturing such nanoparticles.

### BACKGROUND ART

Metal nanoparticles, unlike normal bulk metals, have unique optical, electrical, thermal, and magnetic properties. Metal nanoparticles have attracted attention in numerous fields recently and are expected to find applications in fields such as catalysts, electronic materials, magnetic materials, optical materials, various sensors, colorants, and medical examination. For example, gold and silver nanostructures are particularly fascinating because of their unique optical and catalytic functions, which vary depending on the size and shape. Unfortunately, metal nanoparticles have extremely high surface energy, which may result in oxidation of surface atoms and fusion of the metal nanoparticles due to melting-point depression.

One technique effective in preventing oxidation and fusion of metal nanoparticles is the encapsulation of the nanoparticles with a silica shell. Silica is useful because (1) it is chemically inert in various solutions and are thermally stable, and (2) it can be modified with various functional groups using various silane chemistries. The silica shell is typically formed on the metal nanoparticles by the Stöber process. For example, Ung et al. have developed and proposed a method for forming a silica shell by modifying the surface of metal nanoparticles with a silane coupling agent and then performing a sol-gel reaction in the presence of an ammonia catalyst (see NPL 1). Unfortunately, this method requires a sol-gel reaction in high ammonia concentration and is therefore not environmentally friendly or productive. The silica shell of the core-shell nanoparticles prepared according to NPL 1 is formed on the surface of the metal nanoparticles and has no organic component introduced in the silica matrix thereof. The Stöber process is also not suitable for controlling a sol-gel reaction only on the surface of metal nanoparticles and is therefore not suitable for efficient synthesis of a silica shell with a thickness of 10 nm or less.

Recently, efforts have been directed toward the synthesis of nanosilica by mimicking the formation of biogenic silica in nature, including research on the synthesis of silica nanoparticles in an aqueous medium under mild conditions using a polyamine as a template. It is known that a silica shell of controlled composition and nanostructure can be formed by designing metal nanoparticles modified with an amine that functions as a catalyst to form silica under mild conditions and selectively performing a biomimetic sol-gel reaction on the surface of the metal nanoparticles (see, for example, NPLs 2 and 3). NPL 3 discloses the formation of an organic-inorganic hybrid silica shell through a sol-gel reaction only on the surface of gold nanoparticles modified with an amino acrylate. Unlike silica precipitation based on the Stöber process, the formation of a silica layer using a polyamine present on the surface of gold nanoparticles as a reaction field and catalyst provides an organic-inorganic hybrid containing an acrylate-containing tertiary polyamine introduced in the silica matrix.

Unfortunately, these methods have extremely low productivity and high cost since they require a step of grafting amino acrylate polymer chains to the surface of the metal nanoparticles by special polymerization processes such as living polymerization. The polyamine introduced in the silica matrix of the shell layer in NPL 3 is an acrylate-containing tertiary polyamine. Acrylate-containing tertiary polyamines are not suitable for efficient formation of a silica shell since they have low catalytic activity as a sol-gel reaction field in water because of their relatively high hydrophobicity compared to polyamines, such as polyethyleneimine, containing primary amino groups and/or secondary amino groups. Acrylate-containing tertiary polyamines are also not suitable for selective formation of a silica shell on the surface of metal nanoparticles since it is difficult to form a stable polyamine layer on the surface of metal nanoparticles by physical adsorption using acrylate-containing tertiary polyamines because of their large steric hindrance compared to polyamines, such as polyethyleneimine, containing primary amino groups and/or secondary amino groups.

### CITATION LIST

### Non Patent Literature

NPL 1: T. Ung, et al., Langmuir, 1998, 14, 3740.

NPL 2: P. Graf, ACS Nano, 2011, 5, 820.

NPL 3: S. M. Kang, et al., Nanotechnology, 2006, 17, 4719.

### SUMMARY OF INVENTION

### Technical Problem

In light of the foregoing background, an object of the present invention is to provide core-shell nanoparticles including a metal nanoparticle core and a shell layer composed of an oxide hybridized with a polyamine containing primary amino groups and/or secondary amino groups, core-shell metal nanoparticles prepared by removing the organic component from the shell layer and including a metal nanoparticle core and a shell layer based on silica, and simple and efficient methods for manufacturing such nanoparticles.

### Solution to Problem

After conducting extensive research to achieve the following object, the inventors have found that core-shell nanoparticles can be produced in a simple and efficient manner by performing a sol-gel reaction of an oxide source in the presence of metal nanoparticles having thereon a layer of a compound containing a polyamine segment containing primary amino groups and/or secondary amino groups, thus completing the present invention.

Specifically, the present invention provides a core-shell nanoparticle comprising a core layer consisting of a metal nanoparticle (A) and a shell layer consisting of a hybrid based on a compound (B) and an oxide (C). The compound (B) comprises a polyamine segment (b1) containing primary amino groups and/or secondary amino groups. The present invention further provides a core-shell metal nanoparticle prepared by removing an organic component from the shell layer of the core-shell nanoparticle. The core-shell metal nanoparticle includes a core layer composed of a metal nanoparticle (A) and a shell layer based on silica. The present invention further provides methods for manufacturing such particles.

### Advantageous Effects of Invention

The core-shell metal nanoparticles according to the present invention, which are provided by designing a polyamine present on the surface of metal nanoparticle cores, include a shell layer with a thickness of 20 nm or less, particularly 1 to 10 nm. Unlike existing fine core-shell metal particles, the core-shell nanoparticles according to the present invention include a shell layer having a molecular hybrid structure in which an oxide matrix is homogeneously hybridized with a polyamine. These core-shell metal nanoparticles have polyamine-derived chemical or physical functions. For example, polyamines serve as a strong ligand to allow metal ions to be concentrated in the oxide. Polyamines also serve as a reductant to reduce concentrated noble metal ions into metal atoms, thereby forming oxide-noble metal hybrid nanoparticles. Polyamines also serve as a cationic polymer to provide functions such as antimicrobial and antiviral functions for the nanoparticles. The chemical reactivity of the polyamine present in the shell layer can also be used to introduce molecules such as functional organic molecules and biological molecules. Thus, the core-shell nanoparticles according to the present invention are applicable to numerous fields such as advanced medical diagnostic materials, optical materials, functional fillers, catalysts, and antimicrobial agents.

The methods of manufacture according to the present invention, which involve the use of a reaction mechanism mimicking the formation of biogenic silica, facilitates control of the composition and thickness of the shell layer and allows the production of core-shell nanoparticles that have polyamine functions within a short time under mild reaction conditions, e.g., at low temperature and neutral pH. These methods of manufacture are environmentally friendly, require only a simple production process, and allow structural design depending on different applications.

### BRIEF DESCRIPTION OF DRAWINGS

FIG. 1 is a transmission electron micrograph of core-shell gold nanoparticles obtained in Example 1.

FIG. 2 is a transmission electron micrograph of core-shell silver nanoparticles obtained in Example 2.

FIG. 3 is a transmission electron micrograph of core-shell silver nanoparticles obtained in Example 3.

FIG. 4 is a transmission electron micrograph of core-shell silver nanoparticles obtained in Example 4.

FIG. 5 is a transmission electron micrograph of core-shell silver nanoparticles obtained in Example 5.

### DESCRIPTION OF EMBODIMENTS

The synthesis of an oxide-polymer hybrid shell layer on the surface of metal nanoparticles through a sol-gel reaction in the presence of water is believed to require the following two important conditions: (1) a reaction field for the sol-gel reaction and (2) a catalyst for hydrolysis and polymerization of an oxide source.

To meet these two conditions, a compound (B) containing a polyamine segment (b1) containing primary amino groups and/or secondary amino groups is provided on the surface of metal nanoparticles in the present invention. Metal nanoparticles having thereon primary amino structures and/or secondary amino structures can be readily formed by forming metal nanoparticles in the presence of the compound (B) or by allowing the compound (B) to adsorb onto the surface of metal nanoparticles formed in advance.

The thus-formed metal nanoparticles having thereon primary amino structures and/or secondary amino structures allow a sol-gel reaction of an oxide source in a medium to occur selectively in the layer of the compound consisting of the polyamine segment (b1) on the surface of the metal nanoparticles (A). The polyamine segment (b1) of the compound (B) serves as a reaction field and catalyst to form a shell layer composed of a matrix of the oxide (C) hybridized with the compound (B), thus giving core-shell nanoparticles including a metal nanoparticle core layer. The present invention is based on these findings. A detailed description will be given below.

### Metal Nanoparticles (A)

The cores of the core-shell nanoparticles according to the present invention are metal nanoparticles. The metal nanoparticles may be made of any metal on which the compound (B) containing the polyamine segment (b1) containing primary amino groups and/or secondary amino groups can be immobilized to form a polymer layer. Examples of such metals include noble metals, transition metals, rare earth metals, and alloys and mixtures thereof. Preferred metal nanoparticles include nanoparticles of gold, silver, platinum, palladium, copper, aluminum, nickel, cobalt, silicon, tin, and alloys and mixtures thereof, more preferably nanoparticles of gold, silver, platinum, palladium, copper, silicon, and alloys and mixtures thereof, most preferably gold and silver nanoparticles.

The metal nanoparticles (A) may be of any suitable shape depending on the purpose, including spheres, polyhedrons, wires, fibers, tubes, random structures, and mixtures and combinations thereof. Preferred shapes include spheres, which can be readily synthesized or obtained. The metal nanoparticles (A) are preferably uniform in shape or monodisperse, which is advantageous for ease of handling when the resulting core-shell nanoparticles are used for various applications.

The metal nanoparticles (A) may be of any suitable size, depending on the purpose, that is on the order of nanometers, i.e., from several nanometers to several hundreds of nanometers. Preferably, the metal nanoparticles (A) have a size of 2 to 1,000 nm, more preferably 2 to 100 nm. If the metal nanoparticles (A) are nonspherical, the above size preferably corresponds to the smallest size of the shape of the metal nanoparticles (A). For example, if the metal nanoparticles (A) are wire-shaped, the above size preferably corresponds to the diameter of the metal nanoparticles (A).

Compound (B) Containing Polyamine Segment (b1) Containing Primary Amino Groups and/or Secondary Amino Groups

The polyamine segment (b1) of the compound (B) used in the present invention may be any segment that contains primary amino groups and/or secondary amino groups and that allows a stable polymer layer to be formed on the surface of the metal nanoparticles (A). Examples of such polyamine segments (b1) include branched polyethyleneimine segments, linear polyethyleneimine segments, polyallylamine segments, and polyvinylpyridine segments. Preferred polyamine segments (b1) include branched polyethyleneimine segments, which allow efficient manufacture of a shell layer composed of a matrix of the target oxide (C). The polyamine segment (b1) may have any molecular weight suitable for forming a stable polymer layer with a balance of the solubility in the solution used for the sol-gel reaction of the oxide source (C′) and the ease of immobilization on the surface of the metal nanoparticles (A). Preferably, the polyamine segment contains 5 to 10,000 repeat units, particularly preferably 10 to 8,000 repeat units, which is suitable for forming a stable layer.

The polyamine segment (b1) may have any molecular structure. Examples of suitable structures include linear, branched, dendritic, star-shaped, and comb-shaped structures. Preferred polyamine segments consists of branched polyethyleneimine segments, which can readily function as a template and catalyst for oxide deposition (i.e., for the sol-gel reaction) and are industrially readily available.

The polyamine segment (b1) containing primary amino groups and/or secondary amino groups may be either a homopolymer of a single type of amine unit or a copolymer of two or more types of amine units. The compound (B) may be composed only of the polyamine segment (b1) or may contain other repeat units (segments) provided that a stable polymer layer can be formed on the surface of the metal nanoparticles. To form a stable polymer layer on the surface of the metal nanoparticles (A), repeat units other than polyamine segments are preferably present in the compound (B) in an amount of 50 mol % or less, more preferably 30 mol % or less, most preferably 15 mol % or less.

A preferred repeat unit other than the polyamine segment (b1) is a nonionic organic segment (b2). A graft or block copolymer containing the polyamine segment (b1) and the nonionic organic segment (b2) is preferred because of its dispersion stability in media during the sol-gel reaction. The nonionic organic segment (b2) may be any segment that allows the copolymer to form a stable polymer layer on the surface of the metal nanoparticles (A). Examples of such nonionic organic segments consist of segments of water-soluble polymers such as polyethylene glycol, polyacrylamide, and polyvinylpyrrolidone and segments of hydrophobic polymers such as polyacrylates and polystyrene. To efficiently perform the sol-gel reaction of the oxide source (C′) in aqueous media, water-soluble polymer segments are preferred as the nonionic organic segment (b2). More preferred are polyalkylene glycol segments, which impart biocompatibility to the surface of the resulting core-shell nanoparticles. Most preferred are polyethylene glycol segments.

The nonionic organic segment (b2) may be of any length provided that a polyamine segment layer effective for the sol-gel reaction can be formed on the surface of the metal nanoparticles (A). Preferably, the nonionic organic segment (b2) contains 5 to 100,000 repeat units, particularly preferably 10 to 10,000 repeat units, which is suitable for forming a polyamine segment layer.

The polyamine segment (b1) and the nonionic organic segment (b2) in the compound (B) may be copolymerized in any manner that provides a stable chemical bond. For example, the nonionic organic segment (b2) may be coupled to an end of the polyamine segment or may be grafted to the polyamine segment backbone.

The polyamine segment (b1) and the nonionic organic segment (b2) may be present in the copolymer compound (B) in any proportion provided that a stable polymer layer can be formed on the surface of the metal nanoparticles (A) and that the sol-gel reaction of the oxide source (C′) proceeds only on the surface thereof. Preferably, the polyamine segment (b1) is present in the copolymer compound (B) in a proportion of 5% to 90% by mass, more preferably 10% to 80% by mass, most preferably 30% to 70% by mass, which is suitable for satisfying the above conditions.

The compound (B) used in the present invention can be modified with various functional molecules, either on the polyamine segment (b1) or on the nonionic organic segment (b2). The compound (B) may be modified with any functional molecule that allows a stable polymer layer to be formed on the surface of the metal nanoparticles (A). A modified polyamine segment, which functions as a reaction field and catalyst for oxide deposition on the surface of the metal nanoparticles (A), can form core-shell nanoparticles having any functional molecule introduced therein. In particular, it is preferred to modify the compound (B) with fluorescent compounds. The use of fluorescent compounds provides fluorescent core-shell nanoparticles suitable for applications in various fields.

### Oxide (C)

The oxide (C) in the shell layer may be any oxide that can be deposited by the sol-gel reaction of the oxide source (C′) using the polyamine segment (b1) layer present on the surface of the metal nanoparticles (A) as a reaction field and catalyst to form a stable oxide shell layer. Examples of such oxides include silicon oxide, titanium oxide, zirconium oxide, aluminum oxide, yttrium oxide, zinc oxide, tin oxide, and mixtures and combinations thereof. Preferred oxides include silica, titanium oxide, and zirconium oxide, which can be efficiently deposited on the surface of the metal nanoparticles (A) by an easy and selective sol-gel reaction for a controlled formation of oxide (C). Most preferred are silica and titanium oxide.

### Core-Shell Nanoparticles

The core-shell nanoparticles according to the present invention include a core layer (A) consisting of a metal nanoparticle and a shell layer consisting of a hybrid based on the compound (B) containing the polyamine segment (b1) and the oxide (C). By “based on”, it is meant that no component other than the compound (B) and the oxide (C) is present unless any third component is deliberately introduced. The shell layer is an organic-inorganic hybrid composed of a matrix of the oxide (C) hybridized with the compound (B).

The shell layer of the core-shell nanoparticles according to the present invention has a thickness of 1 to 100 nm, preferably 1 to 20 nm. The thickness of the shell layer of the core-shell nanoparticles can be controlled depending on, for example, the properties of the compound (B) layer present on the surface of the metal nanoparticles (A) (e.g., the type, composition, and molecular weight of the polyamine segment (b1) used and the density of the polyamine segments that form the layer), the type of oxide source (C′), and the sol-gel reaction conditions. The shell layer of the core-shell nanoparticles is significantly uniform since it is formed using the layer of the polyamine segment (b1) of the compound (B) formed on the surface of the metal nanoparticles (A) as a reaction field and catalyst.

The core-shell nanoparticles according to the present invention basically have the same shape as the core, i.e., the metal nanoparticles (A).

The oxide (C) may be present in the shell layer of the core-shell nanoparticles according to the present invention in varying amounts within a certain range depending on, for example, the sol-gel reaction conditions. Typically, the oxide (C) may be present in an amount of 30% to 95% by mass, preferably 60% to 90% by mass, of the entire shell layer. The content of the oxide (C) can be changed depending on, for example, the molecular parameters of the compound (B) on the surface of the metal nanoparticles (A) used in the sol-gel reaction, the type and amount of oxide source (C′), and the sol-gel reaction time and temperature.

A polysilsesquioxane can be incorporated into the core-shell nanoparticles according to the present invention by performing a sol-gel reaction of an organosilane after the deposition of the oxide (C). Such polysilsesquioxane-containing core-shell nanoparticles exhibit high sol stability in solvents. Once dried, the core-shell nanoparticles can be redispersed in media. This contrasts with the case of conventional fine structures coated with oxides (C), which, once dried, are difficult to redisperse in media. Conventional particles coated with oxides (C), which are prepared by processes such as the sol-gel process, are difficult to redisperse in media unless the surface of the particles is chemically modified with materials such as surfactants. Processes such as pulverization are also often required to form nano-level ultrafine particles because the drying results in, for example, secondary aggregation.

If the core-shell nanoparticles according to the present invention are manufactured using a copolymer compound (B) containing the polyamine segment (b1) and polyethylene glycol, which serves as the nonionic organic segment (b2), core-shell nanoparticles having thereon polyethylene glycol segments can be synthesized under controlled sol-gel reaction conditions. Polyethylene glycol segments generally have a lower adsorptivity on the surface of the metal nanoparticles (A) than the polyamine segment (b1). This results in the formation of an adsorbed polyamine segment layer on the surface of the metal nanoparticles (A), followed by the formation of a polyethylene glycol segment layer thereon. The polyethylene glycol segments, which basically have no catalytic effect on the sol-gel reaction, allow selective deposition of the oxide (C) in the polyamine segment layer under controlled sol-gel reaction conditions. The thus-formed core-shell nanoparticles contain polyethylene glycol segments that form the outermost surface thereof.

Polyethylene glycol has a significantly higher mobility than other water-soluble polymers. Polyethylene glycol also has (1) high solvent affinity and (2) a large excluded volume effect, which particularly contribute to the formation of biointerfaces. Polyethylene glycol has good biocompatibility (particularly with blood) and can thus be immobilized on the surface of a substrate to form a non-fouling surface, i.e., a surface resistant to adhesion of proteins and cells. The present invention provides a simple method for synthesizing core-shell metal nanoparticles having polyethylene glycol thereon and is expected to find applications in the field of advanced medical technology.

The core-shell nanoparticles according to the present invention allow metal ions to be highly concentrated and adsorbed onto the polyamine segments (b1) present in the oxide (C) matrix of the shell layer. The chemical reactivity of the amine functional groups in the polyamine segments (b1) also allows the immobilization of various materials such as biological materials and the addition of various functions to the core-shell nanoparticles according to the present invention.

An example of functionalization is the immobilization of fluorescent materials. For example, if a small amount of fluorescent material such as a pyrene or porphyrin is introduced into the polyamine segment (b1), its functional residue is incorporated into the shell layer containing the oxide (C). Fluorescent dyes such as porphyrins, phthalocyanines, and pyrenes can also be incorporated into the shell layer of the nanoparticles by adding a small amount of fluorescent dye containing an acidic group, such as a carboxylic acid or sulfonic acid group, to the basic groups of the polyamine segment (b1).

The compound (B) containing the polyamine segment (b1) can be removed from the shell layer of the core-shell nanoparticles according to the present invention to form nanoparticles including a metal nanoparticle (A) core and an oxide (C) shell layer. Such essentially inorganic core-shell nanoparticles can be used for applications where the presence of organic compounds, particularly the polyamine segment (b1), is undesirable.

The core-shell nanoparticles according to the present invention can be used in the form of a powder and can be used as a filler for other compounds such as resins. Once dried, the powder can be redispersed in solvents to form a dispersion or sol for addition to other compounds. Alternatively, the core-shell nanoparticles according to the present invention can be used in the form of a thin film immobilized on the surface of a substrate.

### Method for Manufacturing Core-Shell Nanoparticles

A method for manufacturing the core-shell nanoparticles according to the present invention includes a step of depositing the oxide (C) by performing a sol-gel reaction of the oxide source (C′) in the presence of the metal nanoparticles (A) having thereon the layer of the compound (B) containing the polyamine segment (b1) containing primary amino groups and/or secondary amino groups. This method may further include, after the step of forming the oxide (C), a step of performing a sol-gel reaction of an organosilane to introduce a polysilsesquioxane (D).

The method of manufacture according to the present invention begins by forming a layer of the compound (B) containing the polyamine segment containing primary amino groups and/or secondary amino groups on the surface of the metal nanoparticles (A). The compound (B) may be directly coupled to the surface of the metal nanoparticles (A) by physical adsorption via coordination bonds between amino groups and the metal surface or may be immobilized via other molecules.

The compound (B) layer may be formed on the surface of metal nanoparticles (A) prepared in advance. Alternatively, metal nanoparticles (A) protected with the compound (B) may be formed in a one-pot process by reducing metal ions in the presence of the compound (B). This one-pot process is preferred in that the polyamine segment (b1) of the compound (B) functions as a stabilizer to allow the reduced metal to grow into nanoparticles and that the reduction reaction can be performed under simple and mild conditions. The polyamine segment (b1) may also function as a reductant in the one-pot process. That is, the polyamine segment (b1) may simultaneously play two roles, i.e., a reductant and a stabilizer, in the formation of the metal nanoparticles (A). To improve the reduction efficiency of metal ions, other reductants may be added to form the metal nanoparticles (A), which can be stabilized in the form of nanoparticles by the compound (B).

The polyamine segment (b1) may be present in the metal nanoparticles (A) having the compound (B) layer thereon in any amount suitable for forming a stable shell layer containing the oxide (C). Typically, the polyamine segment (b1) is present in an amount of 0.01% to 80% by mass, preferably 0.05% to 40% by mass, most preferably 0.1% to 20% by mass.

The polyamine segments in the compound (B) layer on the surface of the metal nanoparticles (A) may be crosslinked with organic compounds having two or more functional groups. Examples of such organic compounds include aldehyde compounds, epoxy compounds, unsaturated double-bond containing compounds, and carboxyl-containing compounds that have two or more functional groups.

The method for manufacturing the core-shell nanoparticles according to the present invention includes, after the step of forming the metal nanoparticles (A) having the compound (B) layer thereon, the step of forming the oxide (C), specifically, the step of performing a sol-gel reaction of the oxide source (C′) using the polyamine segments (b1) present on the surface of the metal nanoparticles (A) as a reaction field and catalyst in the presence of water. As described above, this method may further include, after the step of precipitating the oxide (C), the step of performing a sol-gel reaction of an organosilane to incorporate the polysilsesquioxane (D) into the core-shell nanoparticles.

The metal nanoparticles (A) having the compound (B) layer thereon are preferably used in the sol-gel reaction in the form of a dispersion. Alternatively, the metal nanoparticles (A) having the compound (B) layer thereon may be used in the sol-gel reaction in the form of a film on a substrate.

The sol-gel reaction may be performed by contacting the oxide source (C′) with the metal nanoparticles (A) having the compound (B) layer thereon. In this way, core-shell nanoparticles can be easily formed.

The sol-gel reaction basically does not occur in the continuous phase of the medium; it proceeds selectively only in the layer of the polyamine segments present on the surface of the metal nanoparticles (A). The sol-gel reaction may therefore be performed under any conditions unless the polyamine segments (b1) dissociate from the metal nanoparticles (A).

The oxide source (C′) may be used in the sol-gel reaction in any amount relative to the amount of metal nanoparticles (A) having thereon the layer of the compound (B) containing the polyamine segment (b1). The oxide source (C′) and the metal nanoparticles (A) having the compound (B) layer thereon may be used in any suitable proportion depending on the composition of the target core-shell nanoparticles. To introduce a polysilsesquioxane (D) component into the core-shell nanoparticles after the deposition of the oxide (C), an organosilane is preferably used in an amount of 50% by mass or less, more preferably 30% by mass or less, of the oxide source (C′).

The oxide (C) may be any oxide that can be formed by a sol-gel reaction. Examples of such oxides include silicon oxide, titanium oxide, zirconium oxide, aluminum oxide, yttrium oxide, zinc oxide, tin oxide, and mixtures and combinations thereof, of which silicon oxide and titanium oxide are preferred for their industrial availability and the wide range of applications of the resulting structures.

If the oxide (C) is silica, the oxide source (C′) is a silica source. Examples of silica sources include water glass, tetraalkoxysilanes, and tetraalkoxysilane oligomers.

Examples of tetraalkoxysilanes include tetramethoxysilane, tetraethoxysilane, tetrapropoxysilane, tetrabutoxysilane, and tetra-t-butoxysilane.

Examples of oligomers include tetramethoxysilane tetramer, tetramethoxysilane heptamer, tetraethoxysilane pentamer, and tetraethoxysilane decamer.

If the oxide (C) is titanium oxide, the oxide source (C′) is a titanium source. Water-soluble titanium compounds are preferred for their stability in water. Titanium sources that are unstable in aqueous media can also be used under modified sol-gel reaction conditions.

Examples of water-soluble titanium compounds include titanium bis(ammonium lactato)dihydroxide in water, titanium bis(lactate) in water, titanium bis(lactate) in a mixture of propanol and water, titanium (ethyl acetoacetato)diisopropoxide, and titanium sulfate.

Preferred examples of titanium sources that are unstable in aqueous media include alkoxytitaniums such as tetrabutoxytitanium and tetraisopropoxytitanium. Titanium sources that are stable in aqueous media are preferred since they readily deposit on the surface of the particles.

If the oxide (C) is zirconia, the oxide source (C′) is a zirconia source. Examples of zirconia sources include zirconium tetraalkoxides such as zirconium tetraethoxide, zirconium tetra-n-propoxide, zirconium tetra-isopropoxide, zirconium tetra-n-butoxide, zirconium tetra-sec-butoxide, and zirconium tetra-tert-butoxide.

If the oxide (C) is alumina, aluminum trialkoxides can be used as aluminum sources, including aluminum triethoxide, aluminum tri-n-propoxide, aluminum tri-isopropoxide, aluminum tri-n-butoxide, aluminum tri-sec-butoxide, and aluminum tri-tert-butoxide.

If the oxide (C) is zinc oxide, sources such as zinc acetate, zinc chloride, zinc nitrate, and zinc sulfate can be used. If the oxide (C) is tungsten oxide, sources such as tungsten chloride and ammonium tungstate are suitable.

Examples of organosilanes that can be used to introduce the polysilsesquioxane (D) into the nanoparticles include alkyltrialkoxysilanes, dialkylalkoxysilanes, and trialkylalkoxysilanes.

Examples of alkyltrialkoxysilanes include methyltrimethoxysilane, methyltriethoxysilane, ethyltrimethoxysilane, ethyltriethoxysilane, n-propyltrimethoxysilane, n-propyltriethoxysilane, isopropyltrimethoxysilane, isopropyltriethoxysilane, 3-chloropropyltrimethoxysilane, 3-chloropropyltriethoxysilane, vinyltrimethoxysilane, vinyltriethoxysilane, 3-glycidoxypropyltrimethoxysilane, 3-glycidoxypropyltriethoxysilane, 3-aminopropyltrimethoxysilane, 3-aminopropyltriethoxysilane, 3-mercaptopropyltrimethoxysilane, 3-mercaptotriethoxysilane, 3,3,3-trifluoropropyltrimethoxysilane, 3,3,3-trifluoropropyltriethoxysilane, 3-methacryloxypropyltrimethoxysilane, 3-methacryloxypropyltriethoxysilane, phenyltrimethoxysilane, phenyltriethoxysilane, p-chloromethylphenyltrimethoxysilane, and p-chloromethylphenyltriethoxysilane.

Examples of dialkylalkoxysilanes include dimethyldimethoxysilane, dimethyldiethoxysilane, diethyldimethoxysilane, and diethyldiethoxysilane.

Examples of trialkylalkoxysilanes include trimethylmethoxysilane and trimethylethoxysilane.

The sol-gel reaction may be performed at any temperature. For example, the reaction temperature is preferably 0° C. to 90° C., more preferably 10° C. to 40° C. Even more preferably, the reaction temperature is 15° C. to 30° C., which allows efficient manufacture of the core-shell nanoparticles.

The sol-gel reaction may be performed for any period of time, varying from 1 minute to several weeks. The reaction time for sources with high reactivity may be 1 minute to 24 hours. Preferably, the reaction time is 30 minutes to 5 hours, which allows for a higher reaction efficiency. The sol-gel reaction time for sources with low reactivity is preferably 5 hours or more, and even about 1 week is preferred. The sol-gel reaction of the organosilane is preferably performed for 3 hours to 1 week, depending on the reaction temperature.

As described above, the method for manufacturing the core-shell nanoparticles according to the present invention allows the manufacture of core-shell nanoparticles that, unlike conventional core-shell nanoparticles, include a shell layer having a thickness of 1 to 100 nm, particularly 1 to 20 nm, and composed of a matrix of the oxide (C) in which is introduced the polyamine segment (b1) containing primary amino groups and/or secondary amino groups, which are highly reactive. The resulting core-shell nanoparticles can be modified with polysilsesquioxanes and are expected to find applications in resin fillers.

The core-shell nanoparticles according to the present invention allow the immobilization and concentration of various materials on the polyamine (B) hybridized with the oxide matrix of the shell layer and containing primary amino groups and/or secondary amino groups, which are highly reactive. Because the core-shell nanoparticles according to the present invention allow selective immobilization and concentration of other metals and biological materials and modification with functional molecules in the shell layer on the metal nanoparticles (A), the metal nanoparticles (A) can be hybridized with other materials to provide materials useful in various fields, including electronic materials, biology, and environmentally compatible products.

The core-shell nanoparticles according to the present invention can be functionalized by modifying the surface of the particles with polyethylene glycol segments, which have good biocompatibility, using a copolymer of a polyamine and polyethylene glycol as the compound (B). The thus-obtained core-shell nanoparticles are expected to find applications in the field of advanced medical technology, including sensing and diagnosis.

The method for manufacturing the core-shell nanoparticles according to the present invention allows a shell layer to be formed much more easily than known and widely used methods of manufacture such as the Stöber process. The resulting shell layer is an organic-inorganic hybrid shell layer that cannot be formed by the Stöber process. The core-shell nanoparticles according to the present invention are expected to find a wide range of applications irrespective of the industry and field. These core-shell nanoparticles are useful not only in the general applications of metal nanoparticles (A) and oxides (C), but also in the applications of polyamines.

Removal of Organic Component from Shell Layer

The organic component, i.e., the compound (B), can be removed from the shell layer of the core-shell nanoparticles manufactured as described above to form core-shell nanoparticles having a metal-core, oxide-shell structure. The compound (B) can be removed by processes such as calcination and washing with solvents. A preferred process is calcination in a calcination furnace, by which the organic component, i.e., the compound (B), can be completely removed.

Although the calcination process may be performed either by high-temperature calcination in air and oxygen or by high-temperature calcination in an inert gas such as nitrogen or helium, calcination in air is generally preferred.

The calcination temperature is preferably 300° C. or higher since the compound (B) basically starts decomposing thermally around 300° C. Although the calcination temperature may be any higher temperature at which the core, i.e., the metal nanoparticles (A), can maintain its structure, it is preferably 1,000° C. or lower.

Core-shell nanoparticles containing a polysilsesquioxane may be calcined at any temperature below which the polysilsesquioxane decomposes thermally. For example, if core-shell nanoparticles containing polymethylsilsesquioxane are calcined at 400° C., the compound (B) can be removed to form metal-core, oxide-shell nanoparticles having polymethylsilsesquioxane thereon.

### EXAMPLES

The present invention is further illustrated by the following examples, although these examples are not intended to limit the present invention. Unless otherwise specified, percentages are by mass.

### Examination Under Transmission Electron Microscope

After core-shell nanoparticles were synthesized, the dispersion of the core-shell nanoparticles was diluted with ethanol and was placed on a carbon-deposited copper grid. The sample was examined under a JEM-2200FS microscope available from JEOL Ltd.

### Compositional Analysis of Core-Shell Nanoparticles by X-Ray Fluorescence

About 100 mg of a sample was placed on a piece of filter paper and was covered with a PP film. The sample was examined by X-ray fluorescence (ZSX1002P, Rigaku Corporation).

### Analysis of Shell Layer of Core-Shell Nanoparticles for Organic Content by TGA Measurement

After a core-shell nanoparticle powder was synthesized, the core-shell nanoparticle powder was placed on a platinum pan and was examined by TGA measurement (TG/DTA6300, SII NanoTechnology Inc.)

### Calcination Process

Calcination was performed in an Asahi Rika ARF-100K ceramic electric tubular furnace equipped with an AMF-2P temperature controller.

### Example Synthesis 1

### Synthesis of Gold Nanoparticles Having Thereon Branched Polyethyleneimine Layer

Into 4 mL of water were dissolved 0.2 g of branched polyethyleneimine (SP003, Nippon Shokubai Co., Ltd., average molecular weight: 300) and 0.2 g of tetrachloroauric(III) acid (Wako Pure Chemical Industries, Ltd.). The reaction was performed at room temperature for 24 hours. The mixture, which was initially pale yellow, changed color with the reaction. After 24 hours, a burgundy dispersion of gold nanoparticles was obtained. TEM examination showed that the resulting gold nanoparticles had diameters of 5 to 30 nm.

### Example Synthesis 2

### Synthesis of Silver Nanoparticles Having Thereon Layer of Copolymer of Branched Polyethyleneimine and Polyethylene Glycol

A copolymer can be synthesized by coupling polyethylene glycol segments to the amino groups of branched polyethyleneimine. The method disclosed in Example Synthesis 1 of Japanese Unexamined Patent Application Publication No. 2010-118168 was used to synthesize a copolymer of branched polyethyleneimine having an average molecular weight of 10,000 and polyethylene glycol having a number average molecular weight of 5,000. The molar ratio of ethyleneimine units to ethylene glycol units in the copolymer was 1:3.

Silver nanoparticles were synthesized in the presence of the resulting copolymer by performing a reduction reaction with ascorbic acid in water according to the method disclosed in Example Synthesis 1 of Japanese Unexamined Patent Application Publication No. 2010-118168. The dispersion was purified and concentrated to obtain a grayish-black red dispersion in water of silver nanoparticles having thereon a layer of a copolymer of branched polyethyleneimine and polyethylene glycol. TEM examination showed that the resulting silver nanoparticles had particle sizes of 25 to 40 nm.

### Example 1

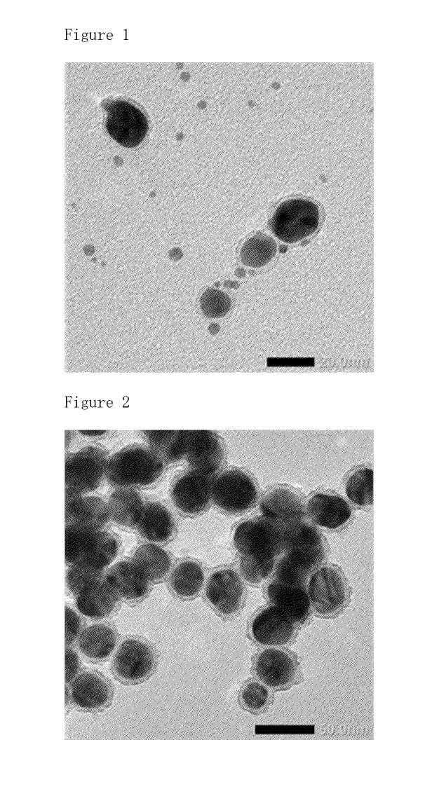

The dispersion of the gold nanoparticles in water obtained in Example Synthesis 1 was used to prepare 10 mL of a dispersion of gold nanoparticles in water with a gold content of 0.25%. To the dispersion, 0.25 mL of MS51 (methoxysilane tetramer) was added as a silica source. The resulting dispersion was stirred at room temperature for 4 hours. The reaction product was washed with and redispersed in ethanol to obtain a dispersion of core-shell gold nanoparticles. TEM examination showed that the resulting particles included a shell layer with a thickness of 4 nm on the surface of the gold nanoparticles (FIG. 1). In the TEM examination, non-templated formation of silica, i.e., the formation of silica in the region other than the surface of the gold nanoparticles, was not observed in the dispersion. This strongly suggests that the polyethyleneimine present on the surface of the gold nanoparticles functions as a scaffold and catalyst for silica precipitation and allows selective formation of silica on the surface of the gold nanoparticles.

The dispersion of the core-shell nanoparticles in ethanol obtained in Example 1 was concentrated and dried to obtain a core-shell nanoparticle powder. This dry powder exhibited good redispersibility due to its silica shell. For example, the powder was readily redispersible in solvents such as water and ethanol. The gold nanoparticles on which the silica shell had yet to be formed fused together as they dried and were not redispersible in media because of the absence of a silica protective layer.

### Comparative Example 1

Gold nanoparticles were synthesized using poly(dimethylaminoethyl methacrylate) (PDMA) according to the method disclosed in Langmuir, 2006, 22(6), 11022-11027. Silica was then deposited as in Example 1. The silica shell was not selectively formed only on the surface of the gold nanoparticles. This is probably because PDMA, which contains only tertiary amines, was less effective in forming a stable hydrophilic polyamine layer on the surface of the gold nanoparticles than branched polyethyleneimine.

### Example 2

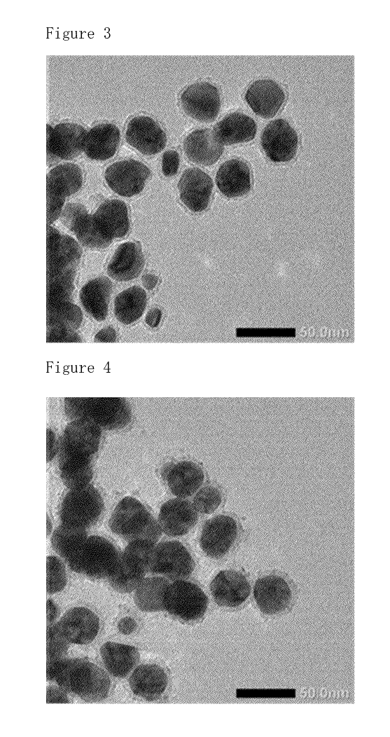

To 25 mL of the dispersion of the silver nanoparticles in water (in a concentration of 0.75%) obtained in Example Synthesis 2, 0.25 mL of MS51 was added as a silica source. The resulting dispersion was stirred at room temperature for 4 hours. The reaction product was washed with and redispersed in ethanol to obtain a dispersion of core-shell silver nanoparticles. TEM examination showed that the resulting particles included a shell layer with a thickness of 9 nm on the surface of the silver nanoparticles (FIG. 2). X-ray fluorescence showed that a dry powder of the core-shell silver nanoparticles had a silica content of 11%.

The polymer layer on the surface of the silver nanoparticles is made of a copolymer of branched polyethyleneimine and polyethylene glycol; thus, the resulting organic/inorganic hybrid shell layer contains nonionic polyethylene glycol.

The dispersion of the core-shell nanoparticles in ethanol obtained in Example 2 was concentrated and dried to obtain a core-shell nanoparticle powder. This dry powder exhibited good redispersibility due to its silica shell. For example, the powder was readily redispersible in solvents such as water and ethanol.

### Example 3

To 25 mL of the dispersion of the silver nanoparticles in water (in a concentration of 0.75%) obtained in Example Synthesis 2, 0.05 mL of MS51 was added as a silica source. The resulting dispersion was stirred at room temperature for 4 hours. The reaction product was washed with and redispersed in ethanol to obtain a dispersion of core-shell silver nanoparticles. TEM examination showed that the resulting particles included a shell layer with a thickness of 3 nm on the surface of the silver nanoparticles (FIG. 3).

### Example 4

To 25 mL of the dispersion of the silver nanoparticles in water (in a concentration of 0.75%) obtained in Example Synthesis 2, 0.25 mL of MS51 was added as a silica source. The resulting dispersion was stirred at room temperature for 40 minutes. The reaction product was washed with and redispersed in ethanol to obtain a dispersion of core-shell silver nanoparticles. TEM examination showed that the resulting particles included a shell layer with a thickness of 5 nm on the surface of the silver nanoparticles (FIG. 4).

The dispersion of the core-shell silver nanoparticles obtained in Example 4 was concentrated and dried to obtain a core-shell silver nanoparticle powder with good redispersibility. TGA measurements on this powder showed that the polymer present in the organic-inorganic hybrid shell accounted for 4% of the entire core-shell particles.

### Example 5

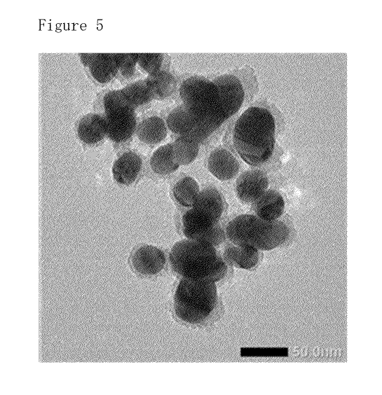

The core-shell silver nanoparticle powder synthesized in Example 4 was calcined in air at 500° C. The calcined sample was evaluated for dispersibility. The sample was determined to have good redispersibility in media. TEM examination showed that the silica shell layer structure was maintained on the surface of the silver nanoparticles (FIG. 5).

### Example 6

### Synthesis of Polysilsesquioxane-Containing Core-Shell Nanoparticles

To 25 mL of the dispersion of the silver nanoparticles in water (in a concentration of 0.75%) obtained in Example Synthesis 2, 0.25 mL of MS51 was added as a silica source. The resulting dispersion was stirred at room temperature for 40 minutes. To the dispersion was added 0.1 mL of trimethylmethoxysilane. The resulting dispersion was stirred at room temperature for 24 hours. The reaction product was washed with and redispersed in ethanol to obtain polysilsesquioxane-containing core-shell nanoparticles. These particles exhibited good redispersibility in solvents such as water and ethanol. These particles were also determined to have good dispersibility in other compounds such as liquid epoxy resins (EPICLON 850S available from DIC Corporation) and dispersions of urethane resins in water.

1. A core-shell nanoparticle comprising:
a core layer consisting of a metal nanoparticle (A); and
a shell layer consisting of a hybrid based on a compound (B) and an oxide (C), the compound (B) comprising a polyamine segment (b1) containing primary amino groups and/or secondary amino groups.

2. The core-shell nanoparticle according to claim 1, wherein the compound (b1) comprising the polyamine segment further comprises a nonionic organic segment (b2).

3. The core-shell nanoparticle according to claim 2, wherein the nonionic organic segment (b2) consists of polyethylene glycol.

4. The core-shell nanoparticle according to claim 1, wherein the shell layer further comprises a polysilsesquioxane (D).

5. The core-shell nanoparticle according to claim 1, wherein the metal nanoparticle (A) is a gold or silver nanoparticle.

6. The core-shell nanoparticle according to claim 1, wherein the polyamine segment (b1) consists of polyethyleneimine.

7. The core-shell nanoparticle according to claim 1, wherein the oxide (C) is silica or titanium oxide.

8. The core-shell nanoparticle according to claim 1 further comprising a shell layer based on an oxide (C).

9. The core-shell nanoparticle according to claim 8, wherein the core-shell nanoparticle is prepared by removing an organic component from the core-shell nanoparticle.

10. A method for manufacturing a core-shell nanoparticle, comprising performing a sol-gel reaction of an oxide source (C′) in the presence of a metal nanoparticle (A) having thereon a layer of a compound (B) comprising a polyamine segment (b1) containing primary amino groups and/or secondary amino groups.

11. The method of manufacture according to claim 10, wherein the method gives the core-shell nanoparticle comprising:
a core layer consisting of a metal nanoparticle (A); and
a shell layer consisting of a hybrid based on a compound (B) and an oxide (C), the compound (B) comprising a polyamine segment (b1) containing primary amino groups and/or secondary amino groups.

12. The method for manufacturing a core-shell particle according to claim 10, further comprising performing a sol-gel reaction of an organosilane.

13. A method for manufacturing a core-shell nanoparticle, comprising performing a sol-gel reaction of an oxide source (C′) in the presence of a metal nanoparticle (A) having thereon a layer of a compound (B) comprising a polyamine segment (b1) containing primary amino groups and/or secondary amino groups; and removing an organic component therefrom.

14. The core-shell nanoparticle according to claim 2, wherein the shell layer further comprises a polysilsesquioxane (D).

15. The core-shell nanoparticle according to claim 3, wherein the shell layer further comprises a polysilsesquioxane (D).

16. The core-shell nanoparticle according to claim 2, wherein the metal nanoparticle (A) is a gold or silver nanoparticle.

17. The core-shell nanoparticle according to claim 3, wherein the metal nanoparticle (A) is a gold or silver nanoparticle.

18. The core-shell nanoparticle according to claim 2, wherein the polyamine segment (b1) consists of polyethyleneimine.

19. The core-shell nanoparticle according to claim 3, wherein the polyamine segment (b1) consists of polyethyleneimine.

20. The core-shell nanoparticle according to claim 2, wherein the oxide (C) is silica or titanium oxide.
